(19) United States
(12) Patent Application Publication
(10) Pub. No.: US 2014/0077649 A1
(43) Pub. Date: Mar. 20, 2014

(54) ELECTRIC MOTOR

(71) Applicant: Gerald Roos, Achern (DE)

(72) Inventor: Gerald Roos, Achern (DE)

(73) Assignee: ROBERT BOSCH GMBH, Stuttgart (DE)

(21) Appl. No.: 14/115,431

(22) PCT Filed: Apr. 13, 2012
(86) PCT No.: PCT/EP2012/056741

§ 371 Date: Nov. 22, 2013

(30) Foreign Application Priority Data
May 4, 2011 (DE) 10 2011 075 195.5

(51) Int. Cl. H02K 1/17

(52) U.S. Cl. CPC H02K 1/17
USPC 310/154.31

(57) ABSTRACT

The invention relates to a rotatory electric motor (1), comprising: a stator arrangement (2) with stator poles having permanent magnet stator poles (P) and consequent poles in an arrangement of consequent poles; and a rotor (6) having an armature made of a magnetically conductive material, with a ratio of the axial length (l) of the armature of the rotor (6) to a diameter (d) of the armature of the rotor from 1 to 2 being provided.

### BACKGROUND OF THE INVENTION

The invention relates to electric motors, in particular electric motors of which the stator poles are arranged in a consequent pole arrangement.

A wide variety of variants of electric motors are known from the prior art. One group of electric motors are the brush-commutated DC motors in which stator poles are formed by permanent magnets in order to provide a rotor, which is provided with a rotor winding, such that it can rotate about the stator arrangement (in the case of external-rotor motors) or in the stator arrangement (in the case of internal-rotor motors).

Only some of the stator poles of the stator arrangement can be formed with permanent magnets. In particular, in the case of a consequent pole arrangement, only each second stator pole in the circumferential direction can be provided with a permanent magnet. The remaining stator poles which are situated therebetween can be formed by a magnetically permeable pole shoe without permanent magnets. In this case, the pole shoe is magnetically permeably connected to the magnet poles of the permanent magnets, for example by means of a pole housing of the stator arrangement, said magnet poles being situated opposite the magnet poles which are oriented in the direction of the rotor.

In stator arrangements with stator poles in a consequent pole arrangement, the magnetic flux which is generated by the permanent magnets generally enters the armature almost entirely by means of the rotor teeth of the rotor and passes through the rotor winding which is arranged on the rotor. A large portion of this magnetic flux is passed to the consequent poles of the stator arrangement by means of the armature. However, a not inconsiderable proportion of the magnetic flux which is generated by the permanent magnet exits at the end faces of the rotor in the axial direction and therefore is not linked to the rotor coils of the rotor winding which are associated with the rotor teeth which face the consequent poles. This proportion of the magnetic flux is called the stray flux, does not form any torque and therefore reduces the efficiency.

The object of the present invention is therefore to provide an electric motor in which a relatively high degree of efficiency of the electric motor can be achieved in spite of the stray flux, which is caused on account of the consequent pole arrangement, at end faces of the rotor.

### SUMMARY OF THE INVENTION

According to a first aspect, a rotary electric motor is provided. The electric motor comprises:
a stator arrangement having stator poles which comprise permanent magnet stator poles and consequent poles in a consequent pole arrangement; and
a rotor having an armature which is composed of a magnetically permeable material,
   characterized in that a ratio between the axial length of the armature of the rotor and a diameter of the armature of the rotor is between 1 and 2.

One idea for designing an electric motor with an optimized degree of efficiency involves firstly reducing the proportion of stray flux in the total magnetic flux which is coupled into the armature, and secondly achieving the greatest possible degree of efficiency in respect of the flux linkage between the rotor and the stator pole with regard to the non-reactive resistance of the rotor winding of the rotor. In particular, the maximum flux linkage at the minimum electrical resistance is achieved by a square or circular coil cross section. Since the coil sides in the direction of a circumferential direction in the rotor are smaller than the axial length of the rotor, this produces optimum axial lengths of the rotor which are smaller than the rotor diameter. As the number of pairs of poles of the rotor increases, and therefore the winding step becomes smaller, the length/diameter ratio of the rotor which is optimum for the maximum flux linkage becomes even smaller. As described above, in the case of consequent pole motors, the stray flux over the end faces of the rotor is not inconsiderable and increases so as to produce small length/diameter ratios, this leading to a reduction in the degree of efficiency. For this reason, a reduction in the length/diameter ratio leads to an impaired degree of efficiency in respect of the magnetic flux used, particularly in the case of motor designs with a relatively large number of pairs of poles in the rotor.

It has been found that the optimum length/diameter ratio of the rotor is always between 1 and 2 for various kinds of consequent pole motors. That is to say, the degree of efficiency of the electric motor can be optimized since a high flux linkage with a low non-reactive resistance of the rotor coils is achieved with a simultaneously low stray flux.

Furthermore, the stator arrangement can be of four-pole design.

According to one embodiment, the rotor can be formed with four or six rotor teeth. As an alternative, the number of rotor teeth can amount to 10 or more.

According to a further embodiment, the electric motor can correspond to a brush-commutated DC motor.

### BRIEF DESCRIPTION OF THE DRAWINGS

Preferred embodiments of the present invention will be explained in greater detail below with reference to the appended drawings, in which:

FIG. 1 shows a schematic cross-sectional illustration through a four-pole consequent pole motor with an internal rotor;

FIG. 2 shows a schematic cross-sectional illustration along an axially parallel plane through the consequent pole motor of FIG. 1; and

FIG. 3 shows a graph for illustrating the profiles of the degree of efficiency depending on a length/diameter ratio of a rotor of a four-pole electric motor with consequent pole arrangement.

### DETAILED DESCRIPTION

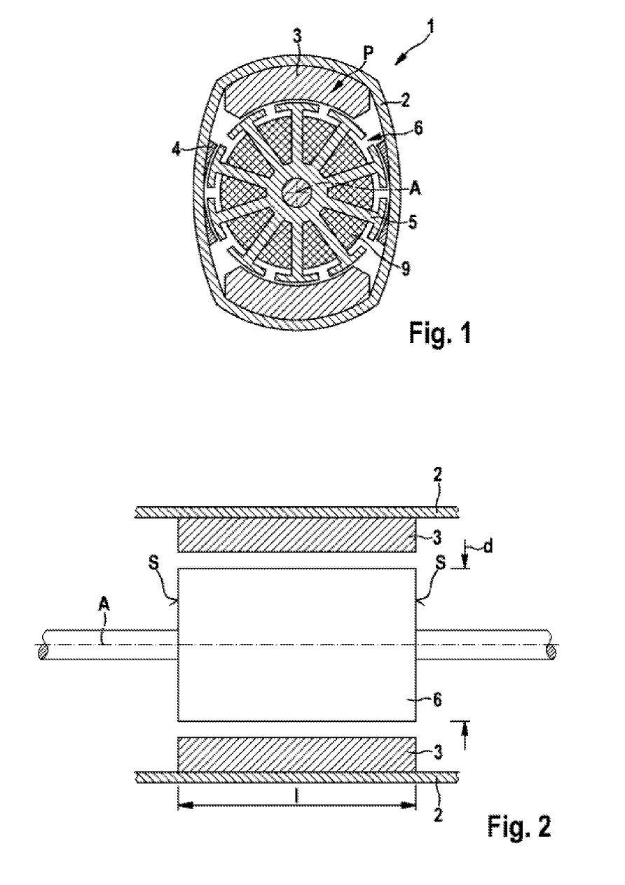

FIG. 1 shows a schematic cross-sectional illustration of an electric motor 1 which is in the form of a brush-commutated DC motor. The electric motor 1 has a magnetically permeable pole housing 2 as a stator arrangement, four stator poles being formed in said pole housing. The pole housing 2 is produced from a magnetically permeable material and has a substantially cylindrical shape with an internal recess in which a rotor 6 (internal rotor) is arranged. Other embodiments can also provide a stator arrangement with outward-facing stator poles around which an external rotor can be arranged.

The rotor 6 is arranged with its armature on a shaft which extends along a center axis A and is mounted in a rotatable manner. The armature of the rotor 6 is fitted with a rotor winding 9, the rotor coils of said rotor winding being wound around rotor teeth 5 of the armature. A commutator (not shown) serves to supply current to the rotor coils. The commutator is formed such that current is supplied to the rotor coils such that the rotor teeth 5 generate a magnetic field which leads to the rotor 6 being driven in a desired direction of rotation.

The pole housing 2 has two mutually opposite permanent magnet stator poles P which are formed with permanent magnets 3. The permanent magnet stator poles are situated opposite one another in relation to the center axis A and the permanent magnets 3 have the same magnetic polarity in the direction of the center axis A. For example, the magnet poles of the permanent magnets 3 which are directed toward the center axis A can correspond to a magnetic north pole.

The pole housing 2 also has two mutually opposite consequent poles 4 which are not formed with permanent magnets. The consequent poles 4 can be formed with a pole shoe and be defined by a magnetically permeable region of the pole housing 2. The pole shoe replicates a contour which substantially corresponds to the movement path of an area which faces the pole housing 2.

The consequent poles 4 are magnetically connected by means of the magnetically permeable pole housing 2 to the magnet poles of the permanent magnets 3 of the permanent magnet stator poles (P), which magnet poles are situated opposite the magnet poles which face the rotor 6. The pole shoes of the consequent poles 4 have an area which is directed toward the rotor 6 and is coupled in a magnetically effective manner to the rotor as a result of its proximity to the armature of the rotor 6.

FIG. 2 shows a schematic cross-sectional illustration through the electric motor 1 of FIG. 1, in which the cross-sectional plane runs parallel to the center axis A. FIG. 2 shows, in particular, the end faces S of the rotor, through which end faces, as described in the introductory part, a proportion of the magnetic flux, which is coupled in by the permanent magnets, can escape in unused form as stray flux. The level of stray flux or the proportion of stray flux in the total flux which is provided by the permanent magnets 3 is a stray flux factor Wₛ which determines the total degree of efficiency W of the electric motor 1. The proportion of stray flux in the total magnetic flux which is coupled into the armature of the rotor 6 by the permanent magnets 3 depends on the length of the rotor 6, in particular on the length l of the armature.

A further aspect which determines the degree of efficiency of the electric motor 1 is the flux linkage in respect of the non-reactive resistance of the rotor winding. Said flux linkage is at an optimum with a square or circular coil cross section since the largest possible area which is enclosed by the rotor coils 9 of the rotor winding with a low non-reactive resistance is achieved in this case. If, in the case of the armature of the electric motor 1, the coil geometry differs from the square coil cross section in the direction of rectangular coil cross sections, the total degree of efficiency of the electric motor 1 likewise reduces by a flux linkage factor W_{F}. Since the width of the rotor coil generally depends on the diameter d of the rotor 6 (inside diameter in the case of external rotors), the optimum degree of efficiency in respect of the flux linkage is found at a length/diameter ratio l/d of the rotor of between 0.3 and 0.8.

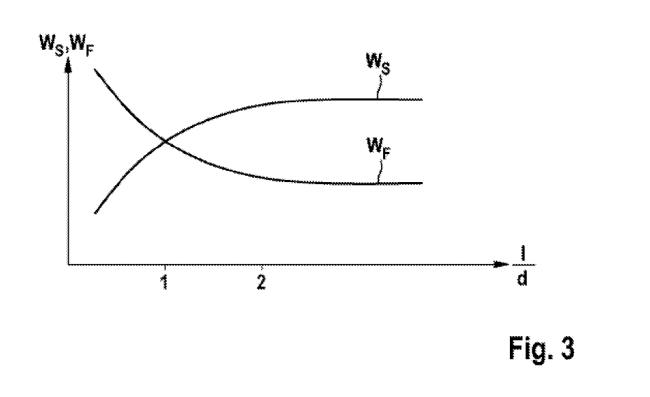

The graph in FIG. 3, in which the stray flux factor Wₛ, which is determined by the stray flux, and the flux linkage factor W_{F} which determine the total degree of efficiency of the electric motor are illustrated with respect to the length/diameter ratio of the rotor 6, shows that there is a suitable compromise in a region in which the length/diameter ratio of the rotor is between 1 and 2. A length/diameter ratio of between 1.2 and 1.7 is particularly advantageous. Even taking into account the mass and the volume of the electric motor 1, said mass and volume depending to a considerable extent on the length/diameter ratio of the rotor, it can be seen that exceeding a length/diameter ratio of 2 would lead to a considerably reduced power density of the electric motor 1 in this case too.

1. A rotary electric motor (1) comprising:
a stator arrangement (2) having stator poles which comprise permanent magnet stator poles (P) and consequent poles in a consequent pole arrangement; and
a rotor (6) having an armature which is composed of a magnetically permeable material, characterized in that a ratio between an axial length (l) of the armature of the rotor (6) and a diameter (d) of the armature of the rotor is between 1 and 2.

2. The electric motor (1) as claimed in claim 1, wherein the stator arrangement (2) is of four-pole design.

3. The electric motor (1) as claimed in claim 1, wherein the rotor (6) is formed with four or six rotor teeth (5).

4. The electric motor (1) as claimed in claim 1, wherein the number of rotor teeth (5) amounts to 10 or more.

5. The electric motor (1) as claimed in claim 1, wherein the electric motor (1) is a brush-commutated DC motor.

6. The electric motor (1) as claimed in claim 1, wherein the ratio between the axial length (l) of the armature of the rotor (6) and the diameter (d) of the armature of the rotor (6) is between 1.2 and 1.7.

7. The electric motor (1) as claimed in claim 1, wherein the armature has electrical rotor coils (9) which approximately form a rectangular coil cross section.

8. The electric motor (1) as claimed in claim 1, wherein respectively opposite permanent magnet stator poles (P) are magnetized with the same polarity in a direction of the center axis A and respectively opposite consequent poles (4) are correspondingly oppositely magnetized with the same polarity in the direction of the center axis A.
